(19) United States
(12) Patent Application Publication
(10) Pub. No.: US 2004/0076575 A1
(43) Pub. Date: Apr. 22, 2004

(54) Method of restricted purification of carbon dioxide

(76) Inventors: Daniel Alvarez JR., San Diego, CA (US); Jeffrey J. Spiegelman, San Diego, CA (US); Russell J. Holmes, Santee, CA (US); Daniel A. Lev, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 10/273,810

(22) Filed: Oct. 17, 2002

(51) Int. Cl. C01B 31/20

(52) U.S. Cl. 423/437.1

(57) ABSTRACT

A method for decontaminating fluid carbon dioxide for use in a product production process such as carbonated beverage production is disclosed. Contaminants, including those normally highly resistant to removal such as S, N, P and Si compounds (especially COS), are removed from the CO₂ by contact with a metal oxide decontamination agent. The metal oxide is one or more oxides of transition metal elements including lanthanides, the iron oxides being preferred. Decontamination of the CO₂ is interrupted at intervals for regeneration of the metal oxide agent by passage of CO₂ containing an oxygen-containing contaminant over the metal oxide in a countercurrent flow direction at higher temperature for a short time. The metal oxide decontaminant may also be mixed with a high-silica content zeolite, preferably a Zeolite Y or zeolite ZSM-5. The contaminated CO₂ and the CO₂ containing an oxygen-containing contaminant are preferably from the same source.

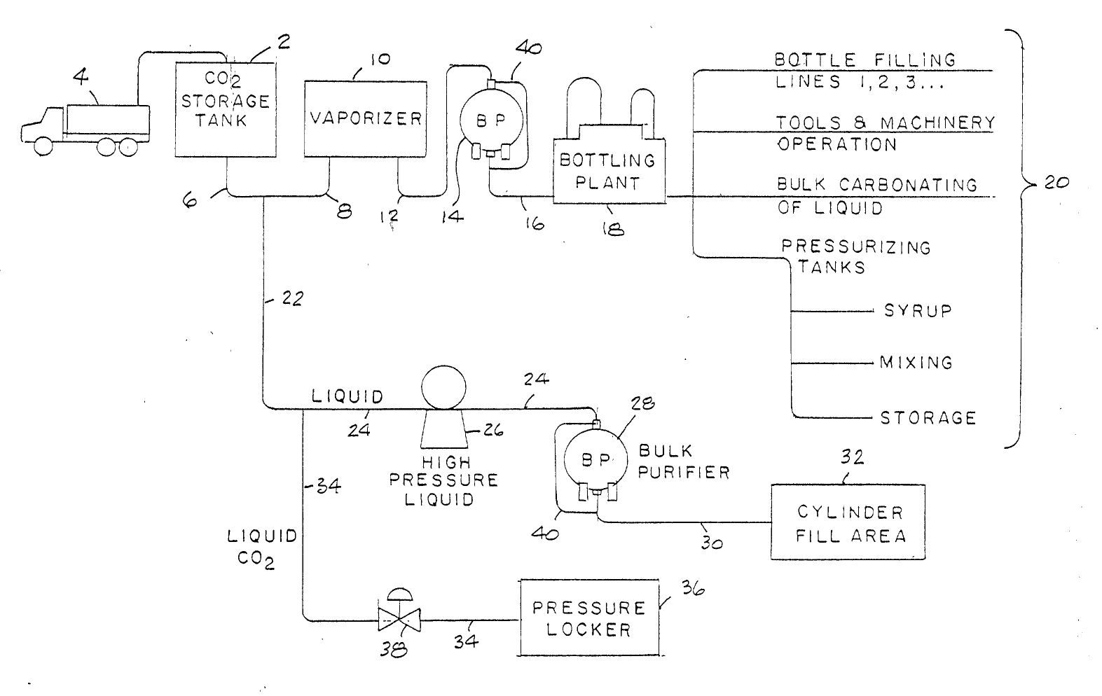

### BACKGROUND OF THE INVENTION

1. Field of the Invention

The invention relates to purification of carbon dioxide (CO₂), particularly for use in the industries that use CO₂ for beverage carbonation, quick freezing and oxidation prevention.

2. Description of the Background

Carbon dioxide is a necessary component in carbonated beverages, such as fruit juices, pop, soda, beer and carbonated water. The carbon dioxide used in the production of these beverages is produced in various ways. One widely used method for producing carbon dioxide is by the burning of fossil fuels and subsequent cryogenic separation of the gaseous products. The various commercial processes produce a variety of contaminants, most commonly hydrocarbons, oxygen, water, carbon monoxide and/or nitrogenous and/or sulfurous compounds.

The International Society for Beverage Technologists has defined three types of carbon dioxide contaminants of concern to the beverage industry. These areas are: (1) sensory—a contaminant that affects the taste or smell of the beverage, e.g., hydrogen sulfide and oxygen; (2) regulatory—a contaminant whose concentration might be controlled by various government regulations, e.g., benzene and phosphine; and (3) process—a contaminant that affects a manufacturing process, e.g., ammonia and carbon monoxide. Among the principal contaminants for which allowable concentration levels has been established are water, oxygen, carbon monoxide, ammonia, nitrogen oxides, ammonia, phosphine, various volatile and aromatic hydrocarbons, acetaldehyde, sulfur dioxide and sulfur content other than as sulfur dioxide. Depending on the contaminant involved, the allowable maximum may be as low as 0.02 ppm (parts per million) or as high as 50 ppm. Beverage manufacturers must have supplies of carbon dioxide with low contaminant levels in order to produce commercial beverages.

Other industries also require carbon dioxide of purity levels similar to those required in beverage production and rapid regeneration of CO₂ supply systems. These industries include, but are not limited to, those which use CO₂ for such reasons as quick freezing and/or prevention of oxidation of foods. For instance, poultry packers use CO₂ for quick freezing of chickens for shipment. Similarly, producers of food products which are susceptible to spoilage from oxidation (such as potato chips, which lose their crispness and flavor as they oxidize) use CO₂ in their packaging equipment and also for package filling to displace ambient oxygen and preserve the food's freshness and flavor. Such industries also require short regeneration times for their CO₂ use systems, since like the beverage industry, they too have only short shut-down intervals in production for cleaning, maintenance and product change-overs. For brevity herein the invention will be described in the context of the beverage production industry, but it will be understood that the invention is not limited to the beverage production industry.

There are currently available decontamination processes which produce bulk quantities of carbon dioxide with purity levels of 99.9% (i.e., 1000 ppm maximum total contamination); see, e.g., the process described in U.S. Pat. No. 4,383,841 (Ryan et al.). However, it is not economic to further purify the CO₂ prior to shipment to the user (i.e., the beverage manufacturer) via canister or tank trailer; see, e.g., the discussion in U.S. Pat. No. 5,910,292 (Alvarez et al.). There are substantial production problems when such bulk shipments have contained unacceptably high levels of one or more individual contaminants within the gas. It is not uncommon for an entire production line contaminated by bad CO₂ (e.g., CO₂ contaminated by sulfurous compounds such as carbon oxysulfide [COS]) to have to be pulled out of use for an extended period for decontamination, which may also extend to that portion of the facility where the line is located. At more extreme levels, if the contamination is not discovered at the production stage, the problem may require that shipped products must be recalled and destroyed. Consequently, users have been forced to rely on “point-of-use” (POU) purification to further reduce the contaminant levels to the required ranges.

While there are numerous prior art processes for removal of some contaminants such as water and oxygen from carbon dioxide and carbon dioxide-containing gases, previous methods of decontamination often could not satisfactorily remove many of the contaminants, such as the sulfurous compounds, which are resistant to removal (sometimes referred to herein as “resistant contaminants” or “resistant materials”). One of the most difficult to remove is COS, which is often in high concentration in CO₂ since contact with sulfurous materials is part of many CO₂ production processes. Other resistant contaminants are nitrogenous, phosphorus and siliceous compounds, both organic and inorganic, such as ammonia.

In addition, many processes for decontamination of CO₂ are ill-suited to the demands of POU purification in beverage manufacturing. One problem arises because many regeneration processes utilize gases which are not only different from those used in beverage production and bottling; for instance, nitrogen, air, oxygen and hydrogen; some of which also may be dangerous when used in a manufacturing context; for instance oxygen and hydrogen. Another problem arises because beverage manufacturing facilities are generally operated on an essentially continuous basis, with only a brief maintenance interruption during a 24-hour period. Therefore, if regeneration of the decontaminant materials used in a POU process is to take place, it must be accomplished during this brief maintenance interruption. In the past no POU processes were available which would allow satisfactory regeneration of their decontaminant materials on a consistent basis at reasonable operating cost in the short downtime intervals dictated by industry operations. See, for instance, the process defined in European Patent No. EP 0 952 111 (Praxair Technology) which while capable of being implemented at the point of use, requires at least eight separate purification steps. Consequently users have had to rely on processes which only partially regenerated the decontaminant materials, which caused the decontamination equipment to have to be taken off line and shut down at frequent intervals for complete regeneration. Other industries using CO₂ also often have time constraints on regeneration of the CO₂ decontamination facilities.

In the past a producer had to have carbon dioxide decontaminated in a separate operation which essentially produced batch quantities of carbon dioxide and which had to be shut down at frequent intervals for regeneration of the decontaminant. The regeneration required extended time periods significantly greater than any normal pause in the production process, such that while the decontaminant was being regenerated, the producer had to rely on a limited stored reserve of decontaminated carbon dioxide in order to continue beverage production. Construction and maintenance of such storage facilities of course adversely affected the economics of the beverage production business. In addition, since there was no correspondence possible between the carbon dioxide production and regeneration operation and the beverage production operation, beverage producers have been unable to develop comprehensive schedules for their overall operations.

### SUMMARY OF THE INVENTION

The invention herein is a novel method for decontaminating fluid carbon dioxide for use in a product production process, such as a beverage production process. In the method of this invention, CO₂ is decontaminated by contact with (e.g., by passage through and/or over) a body of metal oxide decontamination agent at generally ambient temperatures in a forward flow direction. In this manner, CO₂ is produced which is of sufficient quality to be used in beverage production, food packaging, food quick-freezing and similar processes. The method reduces all contaminants present in the raw source (i.e., contaminated) CO₂ to acceptable levels, including the resistant contaminants such as S, N, P and Si compounds. Continuing as part of the process of this invention, the forward flow of the fluid CO₂ is interrupted at intervals for the regeneration of the metal oxide material by contact with (e.g., from passage through and/or over) additional raw source CO₂ at a temperature elevated above ambient flowing in a reverse-flow (countercurrent) direction for sufficient time as to regenerate its decontamination activity to a satisfactory level. Preferably the time period for the reverse flow for regeneration of the decontaminant body will be no greater than the normal downtime (e.g., maintenance or sanitation) period of the commercial product production process in which the decontaminated CO₂ is used. The present process therefore provides such users with a capability heretofore not available—that of having a continuous supply of carbon dioxide decontaminated in conjunction with the production process and on a time schedule concurrent with the normal commercial production schedules.

This invention will be exemplified below by reference to the carbonated beverage production industry, but it will be understood as discussed above that it is generally applicable to industries with requirements for similar levels of CO₂ purity on an on-going schedule which permits only brief intervals for rapid regeneration of the CO₂ production system. It will also be exemplified by reference to resistant sulfur compounds, especially COS, but it will be understood that the process is equally effective for removal of other resistant compounds such as those of nitrogen, phosphorus and silicon, such as ammonia.

For the purposes of this invention, “fluid” carbon dioxide will be defined as CO₂ in ordinary liquid or gaseous form. These phases are well defined in the prior art and do not need to be further described herein. Most commonly in the practice of this invention, CO₂ for decontamination will be in the ordinary liquid phase and following decontamination will be used in the subsequent beverage production or other end use process in the form of ordinary liquid or gas. For brevity the state of the CO₂ as discussed below will often be referred to simply as “fluid” and it will be understood that while the actual phase will determine the specific type of handling equipment which will be used, it will not substantially affect the basic operation of the present process.

Also for the purposes of this invention, “effective decontaminant regeneration” means that the decontaminant must be able to be regenerated sufficiently completely each time that the present regeneration process is run, that the quality of the decontaminated CO₂ product exiting from the decontamination process will remain within the acceptable range over production operations extending for at least two years and preferably for as much as about five years. Stated in another way, the present system permits such rapid, frequent and complete regeneration of the decontaminant material that a beverage manufacturer can generate beverage-grade purity CO₂ for full capacity beverage manufacturing for a continuous period of at least two to three years and commonly for at least five years. Further, when at the end of such time period CO₂ purity level begins to show signs of decline, the reason is more likely to be that the decontamination material itself is becoming physically degraded and needs to be replaced, rather than that the regeneration process is resulting in incomplete regeneration.

Thus the invention disclosed is directed to the removal of contaminants from a stream of fluid carbon dioxide in which the decontaminant materials can be frequently, repeatedly and quickly regenerated in situ to a purity level sufficient to allow extended decontamination of carbon dioxide for use in an user's production operations. The present invention is designed to work equally well for decontamination of fluid carbon dioxide in both gas and liquid phases. This invention is particularly capable of continually producing a supply of carbon dioxide which meets the stringent requirements of the beverage industry over extended periods of time. A notable feature is that it requires only the single raw CO₂ gas source, thus eliminating the need for an external secondary gas source for regeneration. While most of the raw gas is passed through the system for decontamination and subsequently used as purified gas in the beverage production process, the remaining quantity of the raw CO₂ gas can be used for regeneration of the decontamination material.

The method of the present invention involves contacting the fluid carbon dioxide stream containing contaminants (especially resistant contaminants) by passage thereof over and/or through a body of a metal oxide decontamination material having an adsorbent surface. The metal of the oxide will be one or more of the transition metal elements (Periodic Table Groups 7-12) including the metallic lanthanide elements (atomic numbers 58-71). It will be recognized that oxides of some of the metallic elements are not suitable for use in conjunction with some types of end use processes in which the purified CO₂ is to be used, for environmental, safety, health, chemical or other similar reasons, and in such contexts those oxides are not to be used. Examples are some or all of the oxides of nickel or osmium (which are considered to be carcinogenic) and those of promethium (which is an unstable element). It is preferred that the decontaminant be an iron oxide or mixture of iron oxides. Contact of the CO₂ fluid with the metal oxide provides for removal of all important classes of CO₂ contaminants to the desired levels.

The invention also includes the periodic regeneration of the decontaminant material by countercurrent flow of raw source CO₂ which includes oxygen-containing contaminants through and/or over the body of decontaminant material to completely regenerate the metal oxide material body by reversed flow therethrough at a temperature elevated above ambient for a short time period, often four hours or less. The amount of oxygen-containing contaminant present need only be on the order of 1-10 ppm (parts per million) of oxygen gas or 10-50 ppm of water vapor or the equivalent quantity of an analogous gaseous or vaporous oxygen-containing compound. The present invention is therefore unique in its utilization of CO₂ with oxygen-containing contaminants as the medium for regeneration of the metal oxide decontaminant. Use of gas streams which are predominantly or essentially completely CO₂ streams with oxygen-containing contaminants have not previously been considered suitable for regeneration of metal oxide decontamination agents. The presence of the oxygen-containing contaminants is critical; we have found that purified CO₂ cannot be used for regeneration since it cannot accomplish the desired regeneration. It is also important that the raw source CO₂ be passed through the decontaminant agent bed in countercurrent flow, so that the contaminants removed from the process CO₂ during decontamination and adsorbed onto the decontamination agent will upon removal from the agent be entrained in the raw source CO₂ and swept out of the vessel holding the agent through the regular entry port, to avoid possible contamination of the downstream portion of the CO₂ flow system.

In a preferred embodiment the decontamination medium will be a mixture of the metal oxide component and a high-silica content zeolite. The most preferred structures are those of the high-silica Y-type zeolites, especially the synthetic zeolites known commercially as Zeolite Y and ZSM-5.

### BRIEF DESCRIPTION OF THE DRAWINGS

The single FIGURE of the drawings is a schematic diagram of the process of the present invention.

### DETAILED DESCRIPTION AND PREFERRED EMBODIMENTS

The invention herein is a novel method for decontaminating fluid carbon dioxide for use in a commercial process, such as carbonation of potable beverages, in which the contaminant level of all contaminants, but especially of resistant contaminants such as sulfurous, nitrogenous, phosphorus and/or siliceous compounds, is reduced to a level which complies with the allowable limits of the commercial process. The process includes a novel regeneration step that uses a portion of the raw source CO₂ contaminated with oxygen-containing gases, thus eliminating the need for an outside source of regeneration gas. The regeneration of the body or bed of the metal oxide decontaminant in situ can be accomplished in a short time interval, commonly no greater than the normal commercial process downtime. The present process therefore provides, as an example, commercial carbonated beverage producers with a capability heretofore not available—that of having a continuous supply of carbon dioxide decontaminated in conjunction with the beverage production process, on a time schedule concurrent with the normal commercial beverage production schedules, and without the use of additional gas sources for the regeneration.

Commercial production plants producing carbonated beverages such as cola- and non-cola soft drinks, soda water and tonic mixers commonly operate on daily schedule of twenty hours of production and four hours of shutdown for maintenance and cleaning of the production equipment. While a number of prior art processes have been commercially available to produce CO₂ of acceptable purity for beverage carbonation purposes, those processes had shortcomings. One such shortcoming was their inability to reduce many types of S, P, N and Si-containing resistant contaminant levels in the CO₂. The beverage producer was therefore limited in the available sources of the CO₂ and had to use only CO₂ from those vendors who could provide CO₂ with an acceptably low resistant contaminant level to start with, such as by providing CO₂ which had been manufactured by processes which involved little or no amounts of S, N, P or Si source materials. Another shortcoming was that such decontamination processes commonly required long time periods for the periodic regeneration of their decontamination media. Therefore decontaminated CO₂ could not be supplied to the beverage production facility on a long term consistent basis. Rather the beverage producer had to maintain a storage reservoir for decontaminated CO₂ in order to be able to continue beverage production while the CO₂ decontamination facility was shut down for the lengthy regeneration of its decontaminant media.

The present process effectuates excellent reduction of levels of resistant contaminants from the CO₂ while simultaneously removing the less resistant contaminants to levels (for the latter contaminants) which are desired by the end users. While we do not wish to be bound by any particular theory of the chemical mechanism underlying the process of the invention, we believe that the following reactions are significant in the process:

Decontamination: COZ+MOₓ→(M,Z)Oₓ₋₁+CO₂(to process) [1]

Regeneration: (M,Z)Oₓ₋₁+(raw CO₂, H₂O)→MOₓ+ZO+H₂ [2]

where M is a metal element and Z is a resistant element, particularly S, N, P and Si. It is believed that the metal oxide decontamination agent at the low decontamination temperatures serves to oxidize the resistant materials and cause those oxides to associate with the metal oxide, while the residual portion of each resistant material is converted to carbon dioxide (which becomes part of the CO₂ stream) or to another gas which is adsorbed onto the decontaminant and thus removed from the CO₂ stream. Thereafter, on regeneration at an elevated temperature, the oxygen-containing contaminants in the raw CO₂, such as water, converts the metal/resistant oxide back to the metal oxide and the resistant element (which either remains free or more probably combines with oxygen from more of the oxygen-containing contaminant or from the raw CO₂, and in either form is then swept from the oxide body by the countercurrent flow of the raw CO₂. The same also happens with the contaminants of lesser resistance, but those are to have been expected since such contaminants are also removed by prior art processes. The net result is that the source CO₂ is purified of all contaminants, both highly resistant and less resistant, the resistant materials are removed by association with the metal oxides, and thereafter the resistant materials are removed from the system entirely by being re-oxidized and disassociated from the metal oxide by the oxygen-containing contaminants in the raw source CO₂ used for regeneration and removed entirely from the system. The metal oxide, now regenerated and cleansed of the contaminants, especially the resistant ones, is again ready to decontaminate raw source CO₂ for an extended period of time.

The oxygen-containing contaminants such as water vapor or oxygen gas in the raw source CO₂ used for regeneration are the source of the oxygen which causes the disassociation of the mixed resistant element/metal oxide and the resistant material, so as to regenerate the metal oxides and convert the resistant elements to oxides which can be readily removed from the metal oxide body by the countercurrent flow of the raw source CO₂. Again using COS as the example, the metal of the metal oxide must be in a high enough oxidation state to permit release of an oxygen atom from the metal oxide compound to react with the COS to yield CO₂ and to free the S atom from the COS and allow it to associate with the metal oxide under the decontamination temperatures, but also thereafter be capable of having that reaction reversed during high temperature regeneration so that the S atom can be stripped from the metal oxide (along with other adsorbed contaminants) and in free or oxidized form is entrained in the CO₂ regeneration gas stream for removal from the decontaminant bed (in the case of S it is probably in the form of SOₓ or a sulfurous analog). Similar reaction mechanisms can be posed for N, P and Si resistant contaminants, as will be evident to those skilled in the art. Also as will be evident to those skilled in the art, there are other reaction schemes that can also explain the ability of the CO₂ containing the small amounts of the oxygen-containing contaminants to remove the resistant contaminants, so the above proposed mechanism is not to be considered to be a necessary part of the invention as described and claimed herein.

The decontaminants useful in this invention, and which enable the rapid and repeated regeneration, must be such as to remove sufficient contaminants from the fluid carbon dioxide stream that the residual overall contaminant content of the treated fluid after contact with the decontaminant in the decontaminating device is no more than the total of the acceptable levels for all of the contaminants in the carbon dioxide. Representative levels for the maximum allowable contents, as well as the basis for the determination of the limitation, are listed in the Table below.

| | MAXIMUM | BASIS FOR |
|---|---|---|
| CONTAMINANT | CONTENT, ppm | LIMITATION |
| Water (H₂O) | 20 | Process |
| Oxygen (O₂) | 30 | Sensory |
| Carbon Monoxide (CO) | 10 | Process |
| Ammonia (NH₃) | 2.5 | Process |
| Nitrogen Oxides (NO_{X}) | 2.5 | Regulatory |
| Phosphine (PH₃) | 0.3 | Regulatory |
| Volatile Hydrocarbons | 20-50 | Sensory |
| Aromatic Hydrocarbons | 0.02 | Regulatory |
| Acetaldehyde (CH₃COH) | 0.2 | Sensory |
| Sulfur (e.g., COS, excluding SO₂) | 0.1 | Sensory |
| Sulfur Dioxide (SO₂) | 1.0 | Sensory |

It has been found that with the present process, the levels of these typical contaminants in the CO₂ can be reduced to values well below these maxima, usually to levels of no more than 50% of the maximum, preferably no more than 20% of the maximum, and more preferably no more than 10% of the maximum. For the contaminants with the higher allowable limits, the levels can routinely be reduced to levels of 100 ppb or less, preferably 10-25 ppb or less.

Suitable metal oxides are generally oxides of the metals of Groups 7-12 of the Periodic Table. Examples of such metals include Ru, Fe, Mn, Pt, Pd, Re, Zn, Cu, Ir, and Co and the lanthanides. Metals of other groups may also be used where they are capable of reacting during decontamination and regeneration in the manner described above. Also as noted above there will be some metals whose oxides cannot be used in some or all situations for other reasons, but those will be readily known and recognized by those skilled in the art and therefore do not need to be identified in detail herein. Preferred for purposes of the invention are Fe, Mn, Ru, and/or Re oxides, particularly the iron oxides (FeOₓ), either individually or in mixtures. Mixtures of different oxides, including mixtures of iron oxides and other oxides (such as commercial mixed iron/manganese oxides), may also be used. The oxides if desired may be disposed as a coating on a high surface substrate, such as a silica or alumina substrate, but most have sufficient surface area, activity and structural integrity that a substrate is not needed. The various oxides are useful in the present invention as long as they have the requisite high surface area and maintain their structural stability (either alone, mixed or in combination with another metal oxide which has greater structural integrity in the presence of the CO₂ gas stream). By “structural integrity” is meant that the metal oxide substrate can resist erosion or breakage during the course of heat regeneration-cooling cycles, and does not deteriorate by suffering reduction of surface area below about 50 m²/g. This usually translates to a useful service life of between 2 and 5 years.

It will be understood that at different temperatures and in different temperature ranges, there will be a range of metal oxidation states and number of oxides for the individual metals, including iron. The specific temperature ranges, metal oxidation state ranges, number of applicable oxides, and resultant mixture compositions, will differ for each metal element. Those skilled in the art will have no difficulty determining the appropriate values and operating conditions for any oxides of interest.

Several variations of structure are possible. For instance, there may be two or more metal oxides used. Various mixtures may permit the regeneration to be conducted at specific reaction temperatures, especially lower temperatures. Similar effects can be obtained by inclusion of oxides of non-Group 7-12 elements, especially some oxides of Group 1-2 elements, such as calcium, sodium, barium or magnesium. This permits production of decontaminant substrates in situations where to require higher temperatures could raise production problems.

Further, one can integrate oxides of one metal with oxides of another metal to get the decontaminant function of the first metal oxides in situations where they alone would not have sufficient structural strength to function in the present invention. By integrating them into or coating them onto a more structurally sound body of a second oxide group, their advantageous decontamination properties can be utilized notwithstanding their lack of independent structural integrity.

The “oxygen-containing contaminants” referred to herein are gaseous oxygen, water vapor or similar gaseous oxygen-containing compounds. The compounds must have compositions such that their involvement in the decontamination process does not introduce any by-products which are harmful to any aspect of the process. For this reason water is the preferred oxygen-containing contaminant. It also has the advantage of normally being present in the initial CO₂ in sufficient quantities, and the excess water will normally be adsorbed on the metal oxide and removed from the CO₂ gas stream. Since it is present in the gas initially, it does not require any separate input into the gas stream, and therefore no special process equipment is needed for incorporation of the oxygen-containing contaminant. However, use of equipment to incorporate water into the CO₂ stream, such as bubblers, selectively permeable membranes or other conventional devices, is not precluded, although such may not be desirable because of the high costs of such equipment. Oxygen may be effectively used, but normally does require equipment for incorporation into the CO₂ stream, and such equipment is not commonly present in the end user's facility, such as a beverage production plant. Use of unpurified air to provide oxygen is not desirable because it can introduce new contaminants into the CO₂ stream. Use of purified air is feasible, but the cost of the equipment required to purify the air and incorporate it into the CO₂ would be prohibitive.

In another embodiment, the decontamination medium may be a mixture of the metal oxide component and a high-silica content zeolite. While prior art has taught the separate use of metal oxides and zeolites for various “purification” or “decontamination” processes in the past, those systems commonly require extensive regeneration times to restore spent decontamination media to an effective condition. Extended periods for regeneration are not of significance in many fluid decontamination processes, since in those processes the goal is merely to produce quantities of the decontaminated gas for collection for subsequent shipment, dissociated from any particular requirements of the end use of the product fluid as to the manner in which the decontamination system operates to regenerate its decontamination media. It is also well known that regeneration processes cannot be accelerated in most cases, and even where some acceleration is possible, extensive modification of equipment is usually required to accommodate the more severe (and often more hazardous) reaction conditions. Thus, with respect to the present invention, a particular material's mere ability to decontaminate gaseous carbon dioxide to a desired level is not sufficient for guaranteeing that it will be useful. Rather it is critical that the decontamination material must also be capable of being regenerated and restored to its fully effective condition in a short time period consistent with the protocols of the end use process. Commonly these protocols will permit no more than about 6-8 hours of time available for the regeneration to be performed, and often (such as in the beverage production industry) not more than about 3-4 hours. Our invention is unique in that the process of the invention can accomplish such short term regeneration and turn-around of the decontamination system.

In a preferred embodiment the metal oxide will be used in combination with a zeolite to form a combined decontamination medium. The zeolites are a well known and widely described class of natural and synthetic aluminosilicates. For the purposes of this invention, the term “zeolite” will mean any aluminosilicate, natural or synthetic, which has a crystalline structure substantially equivalent to that of the minerals classified as zeolites. The natural zeolites have been widely described in standard mineralogy texts for many years; particularly good descriptions are found in Dana, A TEXTBOOK OF MINERALOGY, pp. 640-675 (4th ed. [rev'd. by Ford]: 1932); Deer et al., AN INTRODUCTION TO THE ROCK FORMING MINERALS, pp. 393-402 (1966) and Kühl et al., “Molecular Sieves,” in Ruthven, ed., ENCYCLOPEDIA OF SEPARATION TECHNOLOGY, vol. 2, pp. 1339-1369 (1997). The synthetic zeolites, which have been developed primarily for use in chemical and petroleum catalytic processes, are often referred to by the prefix word “synthetic” attached to the name of their natural counterparts, or, for those synthetic zeolites which do not have natural counterparts, but various coined names, such as Zeolite A, Zeolite X, Zeolite Y, ZSM-5, and so forth. An excellent description of the synthetic zeolites and their manufacture and uses will be found in the Kühl et al. reference cited above.

Zeolites, both natural and synthetic, have the general formula and structure of (M′,M″).mAl₂O₃.nSiO₂.xH₂O, where M′ and M″ are each usually sodium, potassium, calcium or barium, but may also be strontium, or, rarely, magnesium, iron or other metal cations. The less common cations are found more often in the synthetic zeolites, where they have usually been incorporated for specific catalytic purposes. The coefficients m, n and x will vary according to the specific zeolite considered. The grouping of zeolite “families” is usually based on associating structures having similar ratios of alumina:silica:water. For instance, mordenites normally have Al₂O₃:SiO₂:H₂O ratios of approximately 1:9-10:6-7, heulandites of approximately 1:6-9:5-6 and phillipsites of approximately 1:2:2. Numerous others are illustrated in the above-mentioned references. In the present invention the most preferred structures are those of the high-silica Y-type zeolites, especially the synthetic zeolites known commercially as Zeolite Y and ZSM-5.

For the purposes of the present invention, many conventional natural and synthetic zeolites are not sufficiently active toward contaminant removal to be useful as decontaminating agents for fluid carbon dioxide when rapid regeneration of the decontaminant medium is required. However, we have discovered that if the alumina content of the zeolite is substantially reduced, producing a predominately silica zeolite, and the metal cation content is substantially reduced, the resulting material, which we will refer to herein as a “high silica zeolite,” has superior adsorption properties and, when used in conjunction with the metal oxide, results in a decontaminant medium which can be rapidly and effectively regenerated. For brevity herein, the adsorption agents of the present invention will often be referred to collectively as an exemplary high silica mordenite; it will be understood, however, that the descriptions are applicable to all of the useful high silica zeolites.

The high silica zeolites useful in this invention will have a silica:alumina ratio of at least 20:1, preferably at least 90-1000:1, although high silica zeolites with ratios as high as 2000:1 have been prepared and it is anticipated that the higher ratios will be preferred in specific applications. Their use is therefore contemplated in this invention when they become commercially available. Surface areas of the high silica zeolites are typically up to about 1000 m²/gm, preferably in the range of 800-1000 m²/gm. Normally the high silica zeolites are prepared by treating the original natural or synthetic zeolite with a reactant specific to alumina, so that the alumina content is substantially reduced without affecting the silica content or significantly altering the zeolite structure. Again while not wishing to be bound to any particular theory of the mechanism of decontamination functionality, we believe one reason for the superior performance in the environment of the high silica zeolites is the relative rates of adsorption by silica versus alumina under such conditions.

The mixtures of the zeolites and metal oxides can be used in a variety of different embodiments. For instance, one can simply pass the CO₂ gas through a body consisting substantially or essentially of the substrate, either in a block form or as a body of granules, to the extent that the substrate is sufficiently porous by itself. The substrate can also be in the form of a body of comminuted fine powders. However, using such powders will cause a significant pressure drop in the gas stream, so it is preferred to use a powdered form of the substrate only in high gas pressure systems. It is thus possible to have different forms of the high surface area substrate for gas streams of different pressures, by using different particle sizes.

The present process uniquely and advantageously permits beverage production and CO₂ supply decontamination to operate in close and complete conjunction, such that the beverage producer can operate and maintain an on-site (POU) carbon dioxide decontamination and supply operation as an integral part of the overall beverage production operation. It will be understood that, depending on the size of the decontamination unit and the nature of the contaminants in the CO₂, the decontamination unit may well be capable of producing CO₂ of satisfactory purity over an extended period, so that regeneration of the decontaminant medium may not need to be done daily in conjunction with each maintenance/cleaning shutdown of the beverage production operation. For the present invention, however, it is more important that effective decontaminate regeneration be rapid such that downtime of the decontamination unit is minimized. Regeneration times are commonly on the order of not more than 10-12 hours, and usually are significantly shorter. Commonly the maximum time is determined by the operation of the process for which the CO₂ is being decontaminated. For instance, in the beverage production industry the daily maintenance period is often only four hours, and for the CO₂ decontamination facilities used in such facilities it is important that they be capable of being effectively regenerated during that time period. Thus the beverage production operation is shut down each day for the required maintenance and sanitation, regeneration of the CO₂ decontaminant medium can be conducted simultaneously, such that when the beverage production operation is again ready to come on line the CO₂ decontamination system is also ready to again provide decontaminated CO₂ from a freshly and fully regenerated decontaminant medium.

The operation of the present invention will be best understood by reference to the single FIGURE of the drawings, which illustrates the process by means of a schematic diagram of a system which would be typical of, for instance, use of the invention in a beverage production facility. Fluid carbon dioxide in bulk (usually as ordinary liquid) is delivered to an on-site storage tank 2 at the beverage producer's facility usually by truck 4 (or by pipeline—not shown—if a CO₂ production facility is close by). This CO₂ has normally had some prior decontamination processing to remove solid particles and to reduce levels of contaminants such as water, but the contaminant level is still sufficiently high to be unacceptable for beverage production. In the present process the CO₂ as received is commonly dealt with by either of two operations.

In the most common operation, the contaminated CO₂ is removed from tank 2 and routed through lines 6 and 8 to vaporizer 10 where the liquid CO₂ is vaporized to the gaseous phase. The gaseous CO₂ is then passed through line 12 to bulk purifier 14 where it is contacted with the mixed zeolite/metal oxide decontaminant medium at a temperature on the order of ambient, i.e., in the range of 0°-50° C. [32°-120° F.], and at a pressure on the order of about 50-400 psi [350-2760 kPa] for a period of 0.1-60 minutes. Lower pressures may also be used. Pressures higher than about 400 psi [2760 kPa] are not normally of interest, since they provide no improvement in the process and are beyond the capability of the gas handling equipment of most beverage producers and similar industries. This contacting reduces the contaminant levels in the CO₂ down to and preferably substantially below the allowed maximum limits for the various contaminants, as discussed above. The removed contaminants are sequestered by the decontaminant medium normally by adsorption on the high surface area medium particles, coatings, etc. The decontaminated CO₂ gas is then discharged through line 16 to bottling plant 18 where it is used to carbonate the beverages in a conventional manner. Within the bottling plant the decontaminated CO₂ may be used in a variety of individual operations and with a variety of different types of equipment or products, as indicated by the listing at 20.

In the second type of operation, the liquid CO₂ from the tank 4 is routed through lines 6, 22 and 24 by high pressure liquid pump 26 to a bulk purifier 28 in which it is decontaminated by contact with the decontamination medium of the mixed zeolite and metal oxide at a temperature of 0°-50° C. [32°-120° F.] for a period of 0.1-60 minutes. The decontamination occurs as described above for bulk purifier 14. Following decontamination in bulk purifier 28 the purified liquid CO₂ is passed through line 30 to a cylinder fill area 32 where it is placed in conventional CO₂ cylinders for transport to individual use locations throughout the production facilities on an as-needed basis.

An alternative to the above operations is to pass the contaminated liquid CO₂ from tank 2 through lines 6, 22, and 34 to a pressure locker 36 for alternative storage under the control of valve 38. Thereafter as desired the stored CO₂ can be released back through line 34 to line 24 or lines 22 and 8 for purification and use as described above. This alternative is useful for a large facility where satellite storage of the incoming CO₂ near specific bottling or other beverage processing operations is desired.

Regeneration of the decontaminant media in the bulk processing units 14 and 28 is conducted by shutting off the flow of the CO₂ into a unit and passing a quantity of carbon dioxide gas containing an oxygen-containing contaminant (usually water) into the outlet side of the unit 14 (or 28) for countercurrent flow therethrough. It is preferred that the regeneration gas be a portion of the raw source CO₂ from line 12 (or 24) which can be routed to the outlet end of unit 14 (or 28) through a bypass loop 40 around the unit. The use of bypass loop 40 minimizes the need for elaborate regeneration piping on the effluent side of the purifier. The regeneration gas is at a moderate temperature of 200°-500° C. [390-930° F.], preferably 200°-350° C. [390°-660° F.], more preferably not greater than about 275° C. [530° F.]. While the use of raw source CO₂ is preferred, and is the normal manner of operation of the invention, the use of manufactured or external source regeneration CO₂ with oxygen-containing contaminants is not precluded; such gas may be introduced into line 40 by an external conduit (not shown). The regeneration gas enters the decontaminant chamber from the outlet end and flows through the medium bed in a direction opposite (countercurrent) to that of normal purifier operation. We have found that the presence of the residual oxygen-containing contaminant effectively creates a mildly oxidizing gas which when passed at an elevated temperature through the decontaminant medium bed effectively regenerates and reactivates the bed within a relatively short time. It will be understood that regeneration is conducted to a degree that at the end of the regeneration period the decontaminant medium is capable of producing CO₂ of a purity level sufficient for continued use in the beverage production process. Such regeneration is considered to be “complete” for the purposes of this invention, notwithstanding that some residual adsorbed contaminants may remain on the decontaminant medium.

The invention herein thus overcomes the limitations of the prior art. It provides a high level of carbon dioxide decontamination for a wide variety of the common contaminants found in commercial bulk supplies of carbon dioxide, particularly the resistant compounds, while also permitting complete regeneration of the decontaminant materials in the brief time window customarily available in the commercial beverage production operations. The process therefore allows a user to continue product production operations for extended time periods, without having the production runs prematurely terminated by the increasingly greater contamination of carbon dioxide which resulted from the prior art processes which could only provide partial regeneration, and preferably without the need for an external source of regeneration gas. An end user with the present process can therefore draw up coordinated and comprehensive production operation plans and schedules which focus on other production parameters to maximize product production, knowing that the decontaminant regeneration function will no longer be a limiting factor in the overall production process.

Therefore, the process embodies regeneration cycles sufficient to produce a reactivated adsorbent capable of maintaining activity until the next regeneration. The main requirement of any regeneration or reactivation procedure is that it consistently reproduce purification results over the lifetime of the product, generally up to about 60 months, preferably 48-60 months.

It will be evident that there are numerous embodiments of the present invention which are not expressly described above but which are clearly within the scope and spirit of the present invention. Therefore, the above description is intended to be exemplary only, and the actual scope of the invention is to be determined from the appended claims.

We claim:

1. A method for decontamination of fluid carbon dioxide in conjunction with operation of a process in which said carbon dioxide is used, which comprises:
a. forming a decontaminant body comprising a metal oxide and disposing said body in a vessel having an inlet and an outlet;
b. flowing a stream of contaminated fluid carbon dioxide in a flow direction within said vessel from said inlet to said outlet in contact with said body for decontamination thereof to reduce the amount of contaminants in said fluid carbon dioxide to a level sufficient for subsequent use of decontaminated carbon dioxide in said process, removed contaminants being sequestered by said body, and passing thus decontaminated carbon dioxide on to said process;
c. thereafter and as appropriate to operation of said process, halting flow of said contaminated carbon dioxide stream; and
d. flowing a quantity of carbon dioxide containing an oxygen-containing contaminant in a flow direction within said vessel from said outlet to said inlet in contact with said body for a period of time sufficient to effect regeneration of said body by freeing it of previously sequestered contaminants from said contaminated carbon dioxide;
such that upon halting said regeneration of step d. and restarting passage of said contaminated carbon dioxide through said vessel from said inlet, said body is sufficiently regenerated to decontaminate said contaminated carbon dioxide for renewed discharge from said body and passage of decontaminated carbon dioxide to said process.

2. A method as in claim 1 wherein said decontamination is conducted at a temperature lower than the temperature at which said regeneration is conducted.

3. A method as in claim 2 wherein said decontamination is conducted at a temperature in the range of 0°-50° C.

4. A method as in claim 3 wherein said regeneration is conducted at a temperature in the range of 200°-500° C.

5. A method as in claim 4 wherein said regeneration is conducted at a temperature in the range of 200°-350° C.

6. A method as in claim 5 wherein said regeneration is conducted at a temperature not greater than about 275° C.

7. A method as in claim 1 wherein said oxygen-containing contaminant is water or oxygen gas.

8. A method as in claim 7 wherein said oxygen-containing contaminant is water in a concentration of 10-50 ppm or oxygen in a concentration of 1-10 ppm.

9. A method as in claim 1 further comprising said contaminated carbon dioxide and said carbon dioxide containing an oxygen-containing contaminant being obtained from a single source of carbon dioxide.

10. A method as in claim 9 further comprising extracting said carbon dioxide containing an oxygen-containing contaminant from a conduit upstream of said inlet, passing it around said vessel to said outlet and thereupon passing it into said vessel through said outlet.

11. A method as in claim 1 wherein said carbon dioxide containing an oxygen-containing contaminant is obtained from a second source of carbon dioxide different from a first source of said contaminated carbon dioxide.

12. A method as in claim 11 further comprising said oxygen-containing contaminant having been deliberately incorporated into said carbon dioxide obtained from said second source.

13. A method as in claim 12 wherein said oxygen-containing contaminant is water in a concentration of 10-50 ppm or oxygen in a concentration of 1-10 ppm.

14. A method as in claim 1 wherein said metal oxide comprises an oxide of a metal of Groups 7-12 of the Periodic Table.

15. A method as in claim 14 wherein said metal oxide comprises an oxide of Ru, Fe, Mn, Pt, Pd, Re, Zn, Cu, Ir or Co.

16. A method as in claim 15 wherein said metal oxide comprises an oxide of Fe, Mn, Ru or Re.

17. A method as in claim 16 wherein said metal oxide comprises an iron oxide.

18. A method as in claim 1 wherein said decontaminant body comprises a mixture of metal oxides.

19. A method as in claim 18 wherein said mixture comprises a mixture of oxides of metals of Groups 7-12 of the Periodic Table.

20. A method as in claim 19 wherein said mixture comprises a mixture of oxides of Ru, Fe, Mn, Pt, Pd, Re, Zn, Cu, Ir or Co.

21. A method as in claim 20 wherein said mixture comprises a mixture of oxides of Fe, Mn, Ru or Re.

22. A method as in claim 21 wherein said mixture comprises a mixture of iron oxides.

23. A method as in claim 1 wherein said decontaminant body comprises a mixture of a metal oxide and an oxide of a non-Group 7-12 element.

24. A method as in claim 23 wherein said oxide of a non-Group 7-12 element comprises an oxide of a Group 1-2 element.

25. A method as in claim 24 wherein said oxide of a Group 1-2 element comprises an oxide of calcium, sodium, barium or magnesium.

26. A method as in claim 1 wherein said decontaminant body comprises a mixture of a metal oxide and a high-silica content zeolite.

27. A method as in claim 26 wherein said high silica zeolite has a silica:alumina ratio of at least 20:1.

28. A method as in claim 27 wherein said high silica zeolite has a silica:alumina ratio in the range of at least 90-1000:1.

29. A method as in claim 26 wherein said high silica zeolite comprises Zeolite Y or ZSM-5.

30. A method as in claim 1 wherein said decontaminant body is disposed on a substrate.

31. A method as in claim 30 wherein said substrate comprises alumina or silica.

32. A method as in claim 1 wherein a contaminant removed from said contaminated fluid carbon dioxide comprises a contaminant which is resistant to removal from said carbon dioxide.

33. A method as in claim 32 wherein said contaminant comprises a compound of sulfur, phosphorus, silicon or nitrogen.

34. A method as in claim 33 wherein said contaminant comprises ammonia or an organic compound of sulfur, phosphorus, silicon or nitrogen.

35. A method as in claim 34 wherein said contaminant comprises a compound of sulfur.

36. A method as in claim 35 wherein said contaminant comprises carbon oxysulfide.

37. A method as in claim 1 wherein said period of time sufficient to effect regeneration is not greater than 10-12 hours.

38. A method as in claim 37 wherein said period of time is in the range of 6-8 hours.

39. A method as in claim 37 wherein said period of time is in the range of 3-4 hours.

40. A method as in claim 37 wherein said period of time is determined by operation of said process to which decontaminated carbon dioxide is passed.

41. A method as in claim 1 wherein said process is a carbonated beverage production process.

42. A method as in claim 1 wherein said process is a quick food freezing process.

43. A method as in claim 1 wherein said process is a process which requires use of carbon dioxide to displace oxygen in equipment or packaging.
